(19) United States
(12) Patent Application Publication
(10) Pub. No.: US 2009/0216006 A1
(43) Pub. Date: Aug. 27, 2009

(54) COVALENTLY BOUND POLYSACCHARIDE-BASED CHIRAL STATIONARY PHASES AND METHOD FOR THEIR PREPARATION

(76) Inventors: Hui Xu, (US); Yafeng Zhang, (US); Qiwei Lu, Seven Hills, OH (US)

Correspondence Address: Qi-Wei Lu, 623 Scenic Lane, Seven Hills, OH, 44131, US

(21) Appl. No.: 12/389,055

(22) Filed: Feb. 19, 2009

Related U.S. Application Data
(60) Provisional application No. 61/066,354, filed on Feb. 21, 2008.

(51) Int. Cl. C08B 37/00

(52) U.S. Cl. 536/55.3; 536/18.7

(57) ABSTRACT

The present invention relates to liquid chromatographic chiral stationary phases (CSPs) and their preparation. The CSPs are based on carbamate-derivatized polysaccharides that are covalently bound onto inorganic oxide carriers via unique linkage chemistry. The present invention also relates to methods of obtaining the said linkages, which include derivatizing and functionalizing the polysaccharides, and also chemically bonding the functionalized carbamate-derivatized polysaccharides onto inorganic oxide carriers. The polysaccharide derivatives so obtained can be used as materials for the liquid chromatographic chiral separation of enantiomers. The preferred inorganic oxides are silica, zirconium oxide, and aluminum oxide. Cellulose and amylose are the preferred chiral polysaccharides.

This application claims the benefit of U.S. Provisional Application No. 61/066,354, filed Feb. 21, 2008, which is hereby incorporated by reference herein in its entirety.

### BACKGROUND OF THE INVENTION

1. Field of Invention

The present invention relates to liquid chromatographic chiral stationary phases (CSPs) and their preparation. The CSPs are based on carbamate-derivatized polysaccharides that are covalently bound onto inorganic oxide carriers via unique linkage chemistry. The present invention also relates to methods of obtaining the said linkages, which include derivatizing and functionalizing the polysaccharides, and also chemically bonding the functionalized carbamate-derivatized polysaccharides onto inorganic oxide carriers. The polysaccharide derivatives so obtained can be used as materials for the liquid chromatographic chiral separation of enantiomers.

2. Background and Prior Art

Chiral separation of enantiomers (stereoisomers or diastereomers) becomes increasingly important because of rapidly growing need in many areas of applications, particularly in agricultural and pharmaceutical industries. Study has proven that two enantiomers of a racemic drug have dramatically different or even opposite pharmacological and toxicological activities: one optical form may be medicinally useful and effective, while the counterpart may be inert or even harmful. For example, the (S)-isomer of propranolol is a beta-blocker whereas the (R)-isomer is a contraceptive. Another case is Chloromycetin with only one stereoisomer as an antibiotic and the antipode proved even to interfere with the drug activity. The well-know case is that the (R)-enantiomer of thalidomide is a safe and effective sedative whereas the (S)-enantiomer was discovered to be a potent teratogen. The medical effect of a racemic drug is dictated by the structure of cell surface proteins, which are chiral molecules in nature and requires the structural similarity for an effective interaction. However, regular synthetic routes often result in a mixture of isomers; which explains the fact that many commercial drugs on the market are racemic mixtures of the desired compound and its “mirror image.” The U.S. Food and Drug Administration has recently issued new regulations that drug manufacturers develop quantitative assays for individual enantiomers in in vivo samples in the early stage of drug development and compare the main pharmacological activities of the isomers in vitro systems, both to examine their efficacy, and to minimize undesirable effects attributable to one enantiomer or to the interaction of enantiomers in a racemic mixture.

Chiral separations of enantiomers by chromatographic methods, especially liquid chromatography, have received increasing attention due to their mild conditions, high separation efficiency, and large scale commercial utilization. Current research mainly focuses on the development of chiral stationary phases (hereafter referred to as CSPs; also known as chromatographic resolving agents), i.e., a chiral compound as the separation material plus a chromatographic support.

Polysaccharide such as cellulose, amylase, dextran and starch is one of the most commonly used materials for CSPs due to its bioavailability, inherent chirality and versatility. The superior chiral separation capability is believed to arise from its high order supramolecular structure along with weak interactions like hydrogen bonding, dipole-dipole interaction, and π-π interaction. Meanwhile, the separation efficiency can be further enhanced by proper derivatizaiton. Other than chiral stationary phases, high value-added materials can be produced for other advanced applications, e.g. dialysis membranes, biomimetic actuators, etc. via chemical modification of the primary and/or secondary hydroxyl groups on the repeating units.

However, due to its extensive intra-molecular and inter-molecular hydrogen bonding, polysaccharide has poor solubility in common solvents; which often hinders the chemical modification towards homogeneous materials. Another disadvantage is its high melting point, usually higher than the thermal decomposition temperature. To circumvent the poor processibility of polysaccharide, an initial derivatizing step is usually adopted, i.e., modifying the hydroxyl groups to improve the solubility. The derivatization can also significantly improve the separation efficiency.

In recent years substantial progress has been made by developing a class of CSPs based upon derivatized polysaccharides, especially cellulose, which is physically adsorbed on a carrier such as silica gel, aluminum oxide, or zirconium oxide. For example, the reaction of polysaccharide with isocyanates in pyridine has been developed to produce a carbamate-derivatized polysaccharide. Typically, the carbamate-derivatized polysaccharide is adsorbed on aminopropyl triethoxysilane modified macroporous silica gel with ca. 20 wt % loading. This modified silica gel is packed in stainless-steel columns using a slurry method. This approach has recently been summarized by Y. Okamoto, J Chromatog., 666 (1994), 403-19.

However, a majority of the prior arts employed physical bonding via weak interactions as described in U.S. Pat. No. 4,619,970, U.S. Pat. No. 5,268,442, U.S. Pat. No. 5,589,061, as well as Japanese Pat. No. 1992169595. These weak interactions between the support and polysaccharide inevitably cause a gradual loss of the separation material from the support, resulting in shortened column work life and reduced separation efficiency. Another issue with the adsorbed polysaccharide is a considerably limited number of solvents as eluents; as the polysaccharide has relatively high solubility in good solvents for drugs. These undesirable restrictions will evidently increase the cost of drug development and affect the column versatility.

There exists a prominent need for stable and permanent CSPs and some covalently bound CSPs have been disclosed in prior arts.

Okamoto et al., in European Pat. No. 0,155,637(A, B), have described a chemical process to bind chiral polymers to silica gel. They elaborated in particular the grafting of cellulose tris-2,3,6-phenyl carbamate onto silica gel via a tritylated intermediate and then the formation of the covalent bond between the silica gel and the partially derived polysaccharide carbamate using a diisocyanate.

Okamoto et al., in Japanese Pat. No. 06,206,893A, have described an oligosaccharide chemically bound to silica gel via an amine-reduced imine functional group. The amylose is then regenerated from this oligosaccharide and the residual hydroxyl groups are then converted to carbamates. No evidence of improved column stability against solvent or prolonged column work life is provided by the inventors.

Francotte, in Int. Pat. Appl. No. WO96/27615A, described the immobilization of derived polysaccharides by radiation. It is known that radiation often results in structures with poor reproducibility, as polymerization rate is proportional to radiation strength, which in turn weakens exponentially from the surface to the interior. No example of separation is given.

Francotte et al., in Int. Pat. Appl. No. WO97/04011A, have also described the chemical cross-linking of carbamates and esters of polysaccharides containing no polymerizable group. According to the inventors, crosslinking took place in the presence of a conventional submersible mercury discharge lamp, with or without a photo initiator. The reaction mechanism and the structure of the products obtained are not described. No evidence of improved column stability against solvent or prolonged column work life is given.

Olveros et al, in Int. Pat. Appl. No. WO95/18833A, described polysaccharide derivatives containing an ethylene group, which polymerized with vinyl groups on the silicon gel support. No evidence of improved column stability against solvent or prolonged column work life is provided.

Stuurman et al., in Chromatogr., Vol. 25, No. 4, April 1998, pp. 265-271, investigated the separation of enantiomers using a stationary phase based on hydrosilated quinine chemically bound to silica gel.

Okamoto et al, in J. Liq. Chromatogr., Vol. 10, 1987, pp. 1613-28 and U.S. Pat. No. 4,619,970, recognized the abovementioned methods and provided an alternative approach. One specific limitation is that the covalent bonding takes an undesirable number of process steps to prepare. The polyfunctional organic compounds may cause excessive crosslinking.

House, in U.S. Pat. No. 5,811,532, disclosed stable, non-leaching CSPs, in which a polysaccharide or polysaccharide derivative is covalently bound through a spacer that is isocyanatoalkylene silane to the surface hydroxyl groups of a refractory inorganic oxide. However, the functionalization reaction is under heterogeneous conditions on suspended cellulose particles. Even when the degree of functionalization reaches 20 mol %, the cellulose in general still stays undissolved. Consequentially, silane functional groups are preferentially grafted onto the surface of the cellulose particles and amorphous phases other than crystalline regions, unavoidably leading to an inhomogeneous distribution of silane functional groups, with the highest concentration on the exterior. Meanwhile, on a practical scale, the reproducibility could be a concern if there is any variation on the cellulose grade, batch, particle size/shape and even thermal history. Furthermore, nearly zero functionalization within the core of the cellulose particles leads to non-covalent bonding with the inorganic oxide carrier, whereas the high concentration of alkoxysilane groups near the particle surface may cause self-crosslinking of the cellulose and consequently disrupt its intrinsic supramolecular structure. The sacrifice of chiral recognition ability and separation efficiency was observed in similar studies of immobilization of celluloses on solid supports according to Yashima et al. in J. Chromatogr. A, Vol. 677, 1994, pp. 11-19; Oliveros et al in J. Liq. Chromatogr., Vol. 18, 1995, pp. 1521. The disadvantages of the heterogeneous reactions were discussed by El Seoud and Heinze in Adv. Polym. Sci., Vol. 186, 2005, pp. 103-149.

Duval et al, in U.S. Pat. No. 6,342,592, disclosed the method of synthesizing chiral stationary phases, with the chiral polymers normally in the form of a cross-linked three-dimensional chiral network. As discussed above, crosslinking is difficult to control and disrupts intrinsic supramolecular structure of the chiral polymers. Also, these highly crosslinked beads might not have large enough spaces to accommate drug molecules, not to mention the diffusion of drugs through the beads in a timely manner.

Duval, in U.S. patent application Ser. No. 09/808,910, disclosed the preparation of polymerizable and cross-linkable chloro-, hydroxy- and alkoxysilane derivatives of polysaccharides or oligsaccharides that are either formed as a support or covalently grafted onto a support. The inventor, with strong belief that polymer beads without a support can easily deform under high pressure of liquid chromatography and also lack good chiral recognition ability due to excessive crosslinking, does not want to comment in details on the potential replacement of inorganic oxide carrier. However, as for the covalent bonding approach, the functionalized polysaccharides once again have heterogeneous structures, whose issues were already discussed in the paragraph above.

The foregoing prior arts undoubtedly recognized the underlying problem and offered some rational approaches, yet these are work only at an early stage with significant limitations. In particular, the covalent bonding disrupted the supramolecular structure of polysaccharide and caused a reduced chiral recognition ability. Meanwhile, those methods are proved to be hardly controllable and reproducible for practice on a large commercial scale. The current key challenge confronting the researchers and manufacturers is to find the optimal balance between column work life (i.e. stability against different types of eluents) and separation performance. Therefore, current research and development remain focused on exploring novel preparation methods of covalent bonding while maintaining or even enhancing polysaccharide's chiral recognition ability to the highest degree possible.

Consequently, the present inventors have discovered the development of a chiral stationary phase that is covalently bound to a carrier via unique linkage chemistry, which was obtained through a highly efficient, controllable and reproducible, and also relatively inexpensive process. In present approach, the polysaccharide was first highly or even fully derivatized to become completely soluble using an isocyanate compound. Then the functionalization of the carbamate-derivatized polysaccharide was performed under homogeneous reaction conditions such that an even distribution of functional groups on polysaccharide was achieved. The degree of functionalization was precisely adjusted at a level that the adverse effect on the chiral separation performance could be minimized. The functionalization reaction is highly efficient and the chemistry is novel and was hardly found in the prior arts. The functionalization process was much more controlled and reproducible in contrast to the heterogeneous approaches in the prior arts. Therefore, the CSP in this invention demonstrated superior stability upon all types of solvents, in the mean time maintained, to the highest degree, the good chiral separation performance as demonstrated by traditional physically bound CSPs (e.g. ChiralCel OD by Daicel Co.). The improvements were confirmed by comparing the key separation parameters of the CSP in this invention with some commercial CSPs and the results reported in two prior arts as well. Our solution, described in detail within, is rather general in scope for polysaccharide-based chiral stationary phases, both regarding to their preparation method and final structure.

### OBJECTIVE AND SUMMARY OF THE INVENTION

The objective and motivation of this invention is to develop chiral stationary phases that possess features such as extensive chiral recognition, tolerance over a broad range of solvents, prolonged column work life, high separation resolution & efficiency, as well as low cost raw material inputs and preparation process. While covalent bonding is the right approach to address some of the afore-mentioned issues, it always has an adverse effect on chiral recognition ability as observed in prior arts. The present invention provides process methods of preparing afore-mentioned chiral stationary phases that meet all the requirements. The present invention also provides the preparation of various functionalized carbamate-derivatized polysaccharides via novel chemistry under homogeneous reaction conditions. An embodiment comprises the chiral stationary phase where a silane functionalized carbamate-derivatized polysaccharide is covalently bound to an inorganic oxide carrier. Another embodiment comprises the chiral stationary phase where an epoxy functionalized carbamate-derivatized polysaccharide is covalently bound to an inorganic oxide carrier. Another embodiment comprises the chiral stationary phase where various functionalized carbamate-derivatized polysaccharides are covalently bound to inorganic oxide carriers, wherein the functionality is selected from alkene, thiol, amine, (meth)acrylate, alkene ketone, epoxide, anhydride, carboxylic acid, and aldehyde. In a more specific embodiment the inorganic oxide has chemically bound surface hydroxyl groups and is silica, zirconium oxide, or aluminum oxide. In another more specific embodiment the surface of the inorganic oxide is modified with various surface modifying or coupling agents selected from silane, organic titanate, and organic zirconate to produce various surface functional groups selected from alkene, thiol, amine, (meth)acrylate, alkene ketone, epoxide, anhydride, carboxylic acid, and aldehyde. In yet another specific embodiment the polysaccharide is cellulose or amylose. In a still more specific embodiment the polysaccharide is a carbamate-derivatized cellulose or amylose.

### DESCRIPTION OF THE INVENTION

In the following specification and the claims which follow, reference will be made to a number of terms which shall be defined to have the following meanings. The singular forms “a”, “an” and “the” include plural referents unless the context clearly dictates otherwise. As used herein the term “covalent bonding” is used interchangeably with the terms “chemical bonding” and “permanent bonding”. The terms “carrier” and “support” are used interchangeably.

The problem is to prepare a chiral stationary phase, which possesses extensive chiral recognition capability, which is resistant to leaching upon broad range of solvents applied in liquid chromatography, and which demonstrates high separation resolution and efficiency. Our solution is to chemically bind a carbamate-derivatized polysaccharide to an inorganic oxide carrier that has inherent (i.e. chemically bound) hydroxyl groups on the surface. Our process is straightforward, efficient, well controllable, highly reproducible, and relatively inexpensive, and thus practical for commercial production. The resulting chiral stationary phase product, ultimately consisting of a chiral carbamate-derivatized polysaccharide and an inorganic oxide carrier as the support, showed excellent chiral separation performance and also super stability upon any commonly used solvent and thus significantly prolonged column work life.

The carriers (or supports) of present invention are inorganic oxides include aluminum oxide, titanium oxide, magnesium oxide, zirconium oxide, zirconium silicate, zinc oxide, chromium oxide, silica, silicate, glass spheres, boron oxide, iron oxide, and combinations thereof. Of these carrier materials, silica, zirconium oxide, and aluminum oxide are particularly preferred. Silica and zirconium oxide are more preferred and silica ultimately remains the most preferred carrier.

In one embodiment, the inorganic oxide carrier generally has a particle size of between about 0.05 micron and about 500 micron, preferably between 0.1 micron and 100 micron, more preferably between 0.5 micron and 50 micron, and most preferably between 1 micron and 20 micron.

In another embodiment, the inorganic oxide carrier generally has a surface area of at least about 20 m²/g, preferably greater than 50 m²/g, more preferably greater than 100 m²/g, and most preferably greater than 150 m²/g.

In yet another embodiment, the inorganic oxide carrier is porous and generally has an average pore size of between about 20 angstrom and about 4000 angstrom, preferably between 50 angstrom and 2000 angstrom, more preferably between 100 angstrom and 1000 angstrom, and most preferably between 150 angstrom and 500 angstrom.

In yet another embodiment, it is required that the inorganic oxide carrier have chemically bound hydroxyl (OH) groups on the surface. The carrier powders were baked in an oven for sufficient time at a temperature that effectively removes water molecules adsorbed on the surface. The reason for the requirement of chemically bound hydroxyl groups on the carrier surface is that these hydroxyl groups can react with epoxy groups on the polysaccharide upon heating or with silane functional groups on the polysaccharide to form a covalent O—Si—O linkage.

In one embodiment, the surface of the inorganic oxide carrier is modified by reacting the covalently bound hydroxyl groups on the carrier surface with a surface modifying or coupling agent selected from silane, organic titanate, and organic zirconate to convert the hydroxyl groups to other types of functional groups selected from alkene, thiol, amine, (meth)acrylate, alkene ketone, epoxide, anhydride, carboxylic acid, and aldehyde. In one embodiment, the surface modification is carried out using a small fraction of acidified water as catalyst with or without a solvent media.

Polysaccharides of this invention are selected from the group consisting of cellulose, amylose, amylopectin, dextran, inulin, levan, chitin, pullulan, agarose, starch, and combinations thereof. The polysaccharides of this invention, in either polymeric or oligomeric form, is comprised of monomeric saccharide subunits include alpha-1,4-glucan, alpha-1,6-glucan, beta-1,6-glucan, beta-1,3-glucan, alpha-1,3-glucan, beta-1,2-glucan, beta-1,4-galactan, beta-1,4-mannan, alpha-1,6-mannan, beta-1,2-fructan, beta-2,6-fructan, beta-1,4-xylan, beta-1,3-xylan, beta-1,4-chitosan, beta-1,4-N-acetylchitosan, and so forth. They can be natural or synthetic, crude or purified, original or derivatized or modified. Of these cellulose and amylose and their derivatives are the most preferred polysaccharides used in the practice of this invention.

In one embodiment, chiral polysaccharide, whether synthetic, natural, or modified, has a degree of polymerization of greater than 10, preferably greater than 50, more preferably greater than 100, and most preferably greater than 200.

In another embodiment, chiral polysaccharide, whether synthetic, natural, or modified, can be derivatized with a mono-functional isocyanate compound to form a carbamate linkage to eventually obtain complete solubility in certain common organic solvents. The mono-functional isocyanate is selected from aryl isocyanate, cylcoaliphatic isocyanate, and combinations thereof. 3,5-dimethylphenyl isocyanate, 3,5-dichlorophenyl isocyanate, 3-fluoro-5-methylphenyl isocyanate, 2-methyl-5-fluorophenyl isocyanate, 4-methylphenyl isocyanate, 4-chlorophenyl isocyanate, α-methylbenzyl isocyanate, phenyl isocyanate, cyclopentyl isocyanate, cyclohexyl isocyanate, norbonyl isocyanate, and adamantyl isocyanate are preferable. 3,5-dimethylphenyl isocyanate, 3,5-dichlorophenyl isocyanate, 4-methylphenyl isocyanate, and 4-chlorophenyl isocyanate are most preferable.

In one embodiment, the carbamate-derivatized polysaccharide can be further functionalized on the carbamate linkages under homogeneous reaction conditions to graft the functional groups that are capable of further reacting with functional groups (e.g. hydroxyl, amino, mercapto, (meth)acrylate, etc.) on the surface of an inorganic oxide carrier.

In another embodiment, the carbamate-derivatized polysaccharide can be covalently bound to inorganic oxide carrier through a coupling reaction selected from the group consisting of alkoxysilane/hydroxyl condensation, chlorosilane/hydroxyl condensation, thiol/ene addition, Michael addition, epoxy/amine ring-opening addition, epoxy/hydroxyl ring-opening addition, epoxy/thiol ring-opening addition, acid/amine condensation, anhydride/amine condensation, aldehyde/amine condensation, and ene/ene metathesis.

In one embodiment, the said reactive coupling is obtained using a catalyst include, but are not limited to, free radical generators (e.g. peroxide, azo compounds), base (e.g. 1,4-dihydropyridines, methyl diphenylphosphane, tetramethylguanidine, methyl di-p-tolylphosphane, 2-allyl-N-alkyl imidazolines, tetra-t-butylammonium hydroxide, DBU (1,8-diazabicyclo[5.4.0]undec-7-ene), DBN (1,5-diazabicyclo[4.3.0]non-5-ene), potassium methoxide, sodium methoxide, sodium hydroxide, and the like), acidifying agents (e.g. phosphoric acids, carboxylic acids, acid half esters, inorganic acid-esters, and the like), metal complex (e.g. Grubbs catalyst, metallocene, platinum complex, and the like), carbodiimide, bipyridyl complex.

In another embodiment, the carbamate-derivatized polysaccharide can be covalently bound to inorganic oxide carrier through the condensation with alkoxysilane or chlorosilane functional groups on the polysaccharide.

In yet another embodiment, the carbamate-derivatized polysaccharide can be covalently bound to inorganic oxide carrier through the ring-open addition with epoxide functional group on the polysaccharide.

In one embodiment, the covalent linkage between the polysaccharide and the inorganic oxide carrier has following structure:

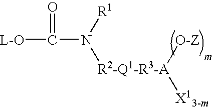

wherein L is polysaccharide; Z is inorganic oxide carrier; m=1-3; A is Si, Ti, or Zr; X¹ is selected from the group consisting of hydrogen, halogen, hydroxyl, alkoxy, acetoxy, siloxane, unsubstituted or substituted alkyl hydrocarbon, unsubstituted or substituted alkenyl hydrocarbon, unsubstituted or substituted aryl hydrocarbon, unsubstituted or substituted mixed alkyl-aryl hydrocarbons, and combinations thereof, wherein the substituents may be selected from the group consisting of halogen, alkoxy, epoxy, hydroxyl, aldehyde, carboxyl, acetoxy, mercapto, amino, cyano, nitro, sulfonyl, and silyl; R¹ is selected from the group consisting of unsubstituted or substituted alkyl, unsubstituted or substituted alkenyl, unsubstituted or substituted aryl, unsubstituted or substituted mixed alkyl-aryl hydrocarbons, and combinations thereof, wherein the substituents may be selected from the group consisting of halogen, alkoxy, epoxy, aldehyde, carboxyl, acetoxy, tertiary amino, cyano, nitro, sulfonyl, and silyl; R² and R³ are independently unsubstituted or substituted alkyl, unsubstituted or substituted alkenyl, unsubstituted or substituted aryl, unsubstituted or substituted mixed alkyl-aryl hydrocarbons, wherein the substituents may be selected from the group consisting of halogen, alkoxy, epoxy, hydroxyl, aldehyde, carboxyl, acetoxy, mercapto, amino, cyano, nitro, sulfonyl, and silyl; and Q¹ is

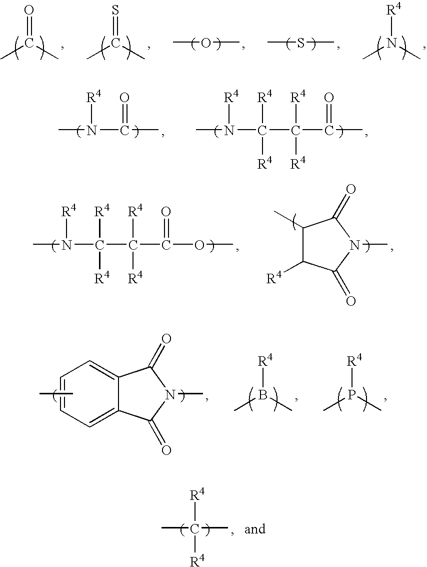

combinations thereof, wherein each occurrence of R⁴ is independently selected from hydrogen, alkyl hydrocarbon, and aryl hydrocarbon.

In another embodiment, the covalent linkage between the polysaccharide and the inorganic oxide carrier has following structure:

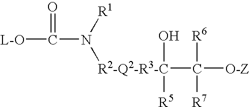

wherein L is polysaccharide; Z is inorganic oxide carrier; R¹ is selected from the group consisting of unsubstituted or substituted alkyl, unsubstituted or substituted alkenyl, unsubstituted or substituted aryl, unsubstituted or substituted mixed alkyl-aryl hydrocarbons, and combinations thereof, wherein the substituents may be selected from the group consisting of halogen, alkoxy, epoxy, aldehyde, carboxyl, acetoxy, tertiary amino, cyano, nitro, sulfonyl, and silyl; R² and R⁵⁻⁷ are independently unsubstituted or substituted alkyl, unsubstituted or substituted alkenyl, unsubstituted or substituted aryl, unsubstituted or substituted mixed alkyl-aryl hydrocarbons, wherein the substituents may be selected from the group consisting of halogen, alkoxy, epoxy, hydroxyl, aldehyde, carboxyl, acetoxy, mercapto, amino, cyano, nitro, sulfonyl, and silyl; and Q² is

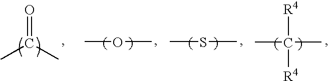

and combinations thereof, wherein each occurrence of R⁴ is independently selected from hydrogen, alkyl hydrocarbon, and aryl hydrocarbon.

In yet another embodiment, the covalently bound chiral polysaccharides themselves have capabilities of separating racemic mixtures, as taught by Okamoto in U.S. Pat. No. 4,861,872 and J. Chromatog., A, 666 (1994), 403-419, which are hereby included in the references.

In general, the chiral stationary phases of present invention may be prepared in following consecutive steps:
a) derivatizing polysaccharides by reacting regular polysaccharides with isocyanate compounds to produce carbamate-derivatized polysaccharides;
b) deprotonating to a small extent the said carbamate-derivatized polysaccharides with a base;
c) grafting functional groups that are capable of further reacting with functional groups (e.g. hydroxyl, amino, mercapto, (meth)acrylate, etc.) on the surface of an inorganic oxide carrier onto the said deprotonated carbamate-derivatized polysaccharides
d) coating and grafting the said functionalized carbamate-derivatized polysaccharides onto an inorganic oxide carrier with or without surface modification.

In one embodiment, the chiral stationary phases of present invention may be prepared in following consecutive steps:
a) derivatizing polysaccharides by reacting regular polysaccharides with isocyanate compounds of formula R¹—NCO to produce carbamate-derivatized polysaccharides, wherein R¹ is selected from the group consisting of unsubstituted or substituted alkyl, unsubstituted or substituted alkenyl, unsubstituted or substituted aryl, unsubstituted or substituted mixed alkyl-aryl hydrocarbons, and combinations thereof, wherein the substituents may be selected from the group consisting of halogen, alkoxy, epoxy, aldehyde, carboxyl, acetoxy, tertiary amino, cyano, nitro, sulfonyl, and silyl;
b) deprotonating to a small extent the said carbamate-derivatized polysaccharides with a base;
c) grafting alkenyl or alkynyl groups onto the said deprotonated carbamate-derivatized polysaccharides by reacting with an unsaturated compound selected from alkenyl compounds of formula X²-J-CH═CH—R⁵ and alkynyl compounds of formula X²-J-C═C—R⁶ wherein X² is independently a leaving group selected from the group consisting of Cl, Br, I, TsO—, MsO—, and TfO—; J is alkyl, aryl, or mixed alkyl-aryl hydrocarbons; R⁵ is independently hydrogen, alkyl, aryl, or mixed alkyl-aryl hydrocarbons;
d) grafting silane functional groups onto the said alkenyl functionalized carbamate-derivatized polysaccharides by reacting with a hydride silane compound of formula HSiX³ₙX⁴₃₋ₙ via hydrosilation, wherein X³ is alkoxy, halide, acetoxy, tertiary amino, enoxy, or oxime; X⁴ is selected from the group consisting of hydrogen, halogen, hydroxyl, alkyl hydrocarbon, alkenyl hydrocarbon, aryl hydrocarbon, mixed alkyl-aryl hydrocarbons, and combinations thereof, n=1-3; and
e) coating and condensating the said silane functionalized carbamate-derivatized polysaccharides onto an inorganic oxide carrier.

In one particular embodiment, Steps (d) and (e) in last paragraph can be further combined to a single step by reacting the deprotonated carbamate-derivatized polysaccharides with a compound of formula X²-T-AX³ₙX⁴₃₋ₙ wherein X² is a leaving group selected from the group consisting of Cl, Br, I, TsO—, MsO—, and TfO—; T is alkyl, alkenyl, aryl, or mixed alkyl-aryl hydrocarbons; A is Si, Ti, or Zr; X³ is alkoxy, halide, acetoxy, tertiary amino, enoxy, or oxime; X⁴ is selected from the group consisting of hydrogen, halogen, hydroxyl, alkyl hydrocarbon, alkenyl hydrocarbon, aryl hydrocarbon, mixed alkyl-aryl hydrocarbons, and combinations thereof, n=1-3.

In a more specific embodiment, the chiral stationary phases of present invention may be prepared in following consecutive steps:
a) derivatizing polysaccharides by reacting regular polysaccharides with excess small mono-functional aryl isocyanate compound of formula (R⁹, R¹⁰)Ph-NCO, wherein R⁹, R¹⁰═H, F, Cl, Br, CH₃—, CH₃O—, or CF₃, or with excess small mono-functional cycloalkyl isocyanate compound of formula R¹¹—NCO, wherein R¹¹ is cyclopentyl, cyclohexyl, norbonyl, or adamantyl, to cap all the hydroxyl groups on the polysaccharides to produce carbamate-derivatized polysaccharides;
b) purifying the said carbamate-derivatized polysaccharides by precipitation in methanol to remove residual small molecules;
c) deprotonating to a small extent the said purified carbamate-derivatized polysaccharides with a base selected from the group consisting of alkali metal hydride of formula MH (e.g. NaH, KH), alkali metal alkylate of formula MR (e.g. sec-butyl lithium), wherein M is alkali metal and R is alkyl hydrocarbon, and alkali metal carbonate or alkaline earth metal carbonate combined with copper (I) halide;
d) grafting vinyl group onto the said deprotonated carbamate-derivatized polysaccharides by reacting with a halovinylalkane of formula X²(CH₂)ₓCH═CH₂, P wherein X² is a leaving group selected from the group consisting of Cl, Br, I, TsO—, MsO—, and TfO—; x=1-16;
e) grafting alkoxysilane or chlorosilane onto the said vinyl functionalized carbamate-derivatized polysaccharides by further reacting with an silane hydride of formula HSiX³ₙX⁴₃₋ₙ via hydrosilation, wherein X³ is alkoxy or chloride; X⁴ is selected from the group consisting of hydrogen, halogen, hydroxyl, alkyl hydrocarbon, alkenyl hydrocarbon, aryl hydrocarbon, mixed alkyl-aryl hydrocarbons, and combinations thereof, n=1-3; and
f) coating and condensing the alkoxysilane or chlorosilane functionalized carbamate-derivatized polysaccharides onto an inorganic oxide carrier.

In another embodiment, the chiral stationary phases of present invention may be prepared in following consecutive steps:
a) derivatizing polysaccharides by reacting regular polysaccharides with isocyanate compounds of formula R¹—NCO to produce carbamate-derivatized polysaccharides, wherein R¹ is selected from the group consisting of unsubstituted or substituted alkyl, unsubstituted or substituted alkenyl, unsubstituted or substituted aryl, unsubstituted or substituted mixed alkyl-aryl hydrocarbons, and combinations thereof, wherein the substituents may be selected from the group consisting of halogen, alkoxy, epoxy, aldehyde, carboxyl, acetoxy, tertiary amino, cyano, nitro, sulfonyl, and silyl;
b) deprotonating the said carbamate-derivatized polysaccharides with a base;
c) grafting epoxy functional groups onto the said deprotonated carbamate-derivatized polysaccharides by reacting with a compound of formula X²-T-X¹, wherein X² is a leaving group selected from the group consisting of Cl, Br, I, TsO—, MsO—, and TfO—; T is alkyl, alkenyl, aryl, or mixed alkyl-aryl hydrocarbons; X⁵ is a glycidyl, aliphatic, or cycloaliphatic epoxy group; and
d) coating and grafting upon heating the said epoxy functionalized carbamate-derivatized polysaccharides onto an inorganic oxide carrier.

In yet another embodiment, the chiral stationary phases of present invention may be prepared in following consecutive steps:
a) derivatizing polysaccharides by reacting regular polysaccharides with isocyanate compounds of formula R¹—NCO to produce carbamate-derivatized polysaccharides, wherein R¹ is selected from the group consisting of unsubstituted or substituted alkyl, unsubstituted or substituted alkenyl, unsubstituted or substituted aryl, unsubstituted or substituted mixed alkyl-aryl hydrocarbons, and combinations thereof, wherein the substituents may be selected from the group consisting of halogen, alkoxy, epoxy, aldehyde, carboxyl, acetoxy, tertiary amino, cyano, nitro, sulfonyl, and silyl;
b) deprotonating the said carbamate-derivatized polysaccharides with a base;
c) grafting functional groups onto the said deprotonated carbamate-derivatized polysaccharides by reacting with a compound of formula X²-T-X⁶, wherein X² is a leaving group selected from the group consisting of Cl, Br, I, TsO—, MsO—, and TfO—; T is alkyl, alkenyl, aryl, or mixed alkyl-aryl hydrocarbons; X⁶ is selected from the group consisting of alkene, thiol, amine, (meth)acrylate, alkene ketone, epoxide, anhydride, carboxylic acid, and aldehyde;
d) modifying an inorganic oxide carrier with covalently bound hydroxyl groups on the surface using a surface modifying or coupling agent of formula X⁶-E-AX³ₙX⁴₃₋ₙ, wherein A is Si, Ti, or Zr; X³ is alkoxy, halide, acetoxy, tertiary amino, enoxy, or oxime; X⁴ is selected from the group consisting of hydrogen, halogen, hydroxyl, alkyl hydrocarbon, alkenyl hydrocarbon, aryl hydrocarbon, mixed alkyl-aryl hydrocarbons, and combinations thereof, n=1-3; X⁶ is selected from the group consisting of alkene, thiol, amine, (meth)acrylate, alkene ketone, epoxide, anhydride, carboxylic acid, and aldehyde; E is alkyl, alkenyl, aryl, or mixed alkyl-aryl hydrocarbons; and
e) coating and grafting the functionalized carbamate-derivatized polysaccharides onto the said surface modified inorganic oxide carrier.

In yet another embodiment, the chiral stationary phases of present invention may be prepared in following consecutive steps:
a) derivatizing polysaccharides by reacting regular polysaccharides with an isocyanate compound of formula R¹—NCO to produce carbamate-derivatized polysaccharides, wherein R¹ is selected from the group consisting of unsubstituted or substituted alkyl, unsubstituted or substituted alkenyl, unsubstituted or substituted aryl, unsubstituted or substituted mixed alkyl-aryl hydrocarbons, and combinations thereof, wherein the substituents may be selected from the group consisting of halogen, alkoxy, epoxy, aldehyde, carboxyl, acetoxy, tertiary amino, cyano, nitro, sulfonyl, and silyl;
b) deprotonating the said carbamate-derivatized polysaccharides with a base;
c) grafting functional groups onto the said deprotonated carbamate-derivatized polysaccharides by reacting with a compound of formula X²-T-X⁶, wherein X² is a leaving group selected from the group consisting of Cl, Br, I, TsO—, MsO—, and TfO—; T is alkyl, alkenyl, aryl, or mixed alkyl-aryl hydrocarbons; X⁶ is hydroxyl that is protected by a compound selected from tetrahydropyran, vinyl ether, and benzyl ether;
d) the hydroxyl protecting group was removed by a benzylsulfonic acid to produce hydroxyl functionalized carbamate-derivatized polysaccharides; and
e) coating and grafting the hydroxyl functionalized carbamate-derivatized polysaccharides onto inorganic oxide carrier upon heating.

In one embodiment, describing our preferred procedure in greater detail, a chiral polysaccharide is functionalized such that there is between about 1 and about 50 functional groups on each of polysaccharide molecule. More desirably the degree of functionalization is between about 1 and 20 per molecule chain and most desirably the degree of functionalization is between about 1 and 10 per molecule chain.

In one embodiment, the said base used for deprotonation is selected from the group consisting of metal hydride, metal alkoxide, alkali metal amide, alkali metal alkylate, alkali metal carbonate or alkaline earth metal carbonate combined with copper (I) halide, and combinations thereof.

The following examples are given to illustrate the preparation of CSP that is based on alkoxylsilane functionalized carbamate-derivatized polysaccharide chemically bound onto an inorganic oxide carrier. These examples are merely exemplary of present invention and are not intended to limit it in any way. Variants will be readily appreciated by those skilled in the art, and it is intended that these variants be subsumed within present invention as claimed.

### Example 1

### Synthesis of Carbamate-Derivatized Celluloses

Isocyanate modified cellulose (carbamate-derivatized cellulose) was prepared according to a modified literature method using a phenyl isocyanate to derivatize the cellulose. In this embodiment, powder of microcrystalline cellulose (10.0 g, 61.7 mmol sugar repeat unit) was suspended in pyridine (200 mL) and the flask was purged with nitrogen for 15 min at room temperature. 3,5-dimethylphenyl isocyanate (30.0 mL, 210 mmol) was added to the suspension via syringe. The solution was stirred at 90-100° C. under a nitrogen atmosphere for 12 hr. The starting cellulose is insoluble in reaction media, and it was gradually dissolved into pyridine to form a clear light-yellow viscous solution as the reaction proceeded under heating. The viscous solution was then precipitated into methanol, and the filtered precipitate was redissolved in acetone, and reprecipitated in methanol to give 30.0 g (91% yield) of tris(3,5-dimethylphenylcarbamate) cellulose (I). Pyridine, unreacted isocyanate, and urea formed during reaction were thus removed by the direct precipitation and washing. A second precipitation in acetone/methanol gave pure carbamate-derivatized cellulose. The yields were greater than 90% and the degree of functionalization was almost quantitative according to ¹H NMR. The number average molecular weight of carbamate-derivatized cellulose was ˜90,000 g/mol with a PDI of 2.5 relative to polystyrene standard.

### Example 2

### Synthesis of Vinyl Functionalized Carbamate-Derivatized Celluloses

To a solution of tris(3,5-dimethylphenylcarbamate) cellulose (I, 15.0 g, 25.0 mmol of sugar unit or 75.0 mmol of carbamate) in DMF (120 mL), NaH (60% in mineral oil, 0.1 g, 2.5 mmol) was added at ambient temperature. After 60 min, 10-bromo-1-decene (165 mg, 0.75 mmol) in 30 mL of DMF was added via syringe, stirred at room temperature for 12 hr. The pH of the solution was adjusted to 5 using 6M HCl and the solution was precipitated in a 20:1 mixture of methanol:hexane. The filtered solid was dissolved in acetone and reprecipitated in methanol to give 14.1 g (94% yield) of vinyl functionalized carbamate-derivatized celluloses (II). Ca. 1 mol % of vinyl functionality (relative to carbamate functionality) was grafted, which was quantified by ¹H NMR spectroscopy.

### Example 3

### Synthesis of Alkoxysilane Functionalized Carbamate-Derivatized Celluloses

To a solution of vinyl functionalized carbamate-derivatized celluloses (II, 7.2 g, 0.36 mmol of vinyl functionality) in THF (100 mL), HSi(OC₂H₅)₃ (73.8 mg, 0.45 mmol), and chloroplatinic acid (H₂PtCl₆.6H₂O, 9.3 mg, 5 mol %) were added at ambient temperature. The reaction mixture was stirred at 40° C. for 6 hr and then concentrated to afford alkoxysilane functionalized carbamate-derivatized celluloses (III).

### Example 4

### Preparation of Chiral Stationary Phase and HPLC Column

Alkoxysilane functionalized carbamate-derivatized cellulose (III, 200 mg) was dissolved in dry THF. Particles of silica gel (7 g, average diameter of 5 μm, average pore size of 200 Å) were then added to the solution to form a suspension by vigorous swirling. Five aliquots of mixture of glacial acetic acid/deionized water/ethanol (Jan. 50, 1975) were added into the suspension to catalyze the condensation of alkoxysilane on the carbamate-derivatized celluloses onto the surface of the silica gel particles. The suspension was sonicated for 15 min and stirred under controlled constant vacuum overnight. Particles were collected by filtration, followed by THF washing to remove unbound cellulose and dried under vacuum at ambient temperature. The amount of cellulose loading was determined by elemental analysis. This final product of the covalently bound particles (IV) comprised of carbamate-derivatized cellulose and silica gel will be used as liquid chromatographic chiral stationary phases for enantiomers separation.

HPLC column packing: carbamate-derivatized celluloses coated silica gel particles (4 g) were suspended in 18 mL of methanol and sonicated at 50° C. for 60 min. After sonication, the column (100×4.6 mm) was packed using a high-pressure (7000 psi) slurry method in methanol.

### Example 5

### Synthesis of Hydroxyl Functionalized Carbamate-Derivatized Celluloses

To a solution of tris(3,5-dimethylphenylcarbamate) cellulose (I, 15.0 g, 25.0 mmol of sugar unit or 75.0 mmol of carbamate) in DMF (120 mL), NaH (60% in mineral oil, 0.1 g, 2.5 mmol) was added at ambient temperature. After 60 min, 11-O-tetrapyranundecylbromide (252 mg, 0.75 mmol) in 30 mL of DMF was added via syringe, stirred at room temperature for 12 hr. 11-O-tetrapyranundecylbromide was prepared from the reaction between 11-bromoundecyl alcohol and tetrahydropyran following a standard procedure that has been reported in a great deal of publications. The pH of the solution was adjusted to 5 using 6M HCl and the solution was precipitated in a 20:1 mixture of methanol:hexane. The filtered solid was dissolved in acetone (200 mL), and methanol (20 mL) and TsOH (100 mg) were added. The solution was stirred at room temperature for 4 hr and precipitated in methanol to give 12.5 g (83% yield) of hydroxyl functionalized carbamate-derivatized celluloses (V). Ca. 3 mol % of hydroxyl functionality (relative to carbamate functionality) was grafted, as confirmed by nuclear magnetic resonance (NMR).

### Example 6

### Preparation of Chiral Stationary Phase

Hydroxyl functionalized carbamate-derivatized cellulose (V, 200 mg) was dissolved in dry THF. Particles of silica gel (7 g, average diameter of 5 μm, average pore size of 200 Å) were then added to the solution to form a suspension by vigorous swirling. The suspension was sonicated for 15 min and stirred under controlled constant vacuum overnight. Particles were collected by filtration and heated at 130° C. for 24 hr under vacuum. The particles were washed by THF to remove unbound cellulose and dried under vacuum at ambient temperature. The amount of cellulose loading was determined by elemental analysis and thermogravimetric analysis (TGA). This final product of the covalently bound particles (VI) comprised of carbamate-derivatized cellulose and silica gel will be used as liquid chromatographic chiral stationary phases for enantiomers separation.

### Example 7

### Trial Separation on Representative Racemates

The separation efficiency of our covalently bound CSPs (IV) was evaluated on 7 racemates. The two main parameters, separation factor (α) and retention factor (k′), were summarized in Table 1 and also compared with the results from non-covalently bound ChiralCel OD column as control.

The retention factor, k′, is calculated as the difference of the retention volume of peak X (V_{X}) and column dead volume (V_{O}) divided by the column dead volume (Equation 1). The retention time is mainly dependent on the solvent polarity.

$${k}^{′} = \frac{{V}_{X} - {V}_{0}}{{V}_{0}} = \frac{{t}_{X} - {t}_{0}}{{t}_{0}} \qquad ( 1 )$$

Separation factor, α, is defined by the ratio of k′s of the two peaks (Equation 2), which stands for the relative separation between two peak centers. For example, α=1 means that there is no separation between two compounds.

$$α = \frac{{V}_{B} - {V}_{0}}{{V}_{A} - {V}_{0}} = \frac{{t}_{B} - {t}_{0}}{{t}_{A} - {t}_{0}} = \frac{{k}_{B}^{′}}{{k}_{A}^{′}} \qquad ( 2 )$$

TABLE 1
Separation results of some racemates with covalently
bound carbamate-derivatized cellulose based CSPs

| | Separation Factor (α) | | Retention Factor (k′) | |
|---|---|---|---|---|
| | Control | CSP of | Control | CSP of |
| | (ChiralCel | Example | (ChiralCel | Example |
| Racemate | OD) | 4 | OD) | 4 |
| 2,2,2-Trifluoro-1-(9- | 3.33 | 3.65 | 2.07 | 0.95 |
| anthryl) ethanol | | | | |
| 1-Phenyl-1-propanol | 1.16 | 1.50 | 3.75 | 2.01 |
| α-Methyl-1-naphthanlene | 1.89 | 2.14 | 9.88 | 5.07 |
| methanol | | | | |
| Trans-stilbene oxide | 1.88 | 3.03 | 1.24 | 0.71 |
| Burke O₂ | 2.49 | 3.12 | 6.51 | 3.93 |
| 3,5-Dinitro-N(1-phenyl- | 1.19 | 1.90 | 20.73 | 8.14 |
| ethyl) benzamide | | | | |
| Napropamide | 1.19 | 1.59 | 1.15 | 0.65 |

(Column dimension: 100 × 4.6 mm; mobile phase: hexane/isopropanol, 90/10)

The results obtained with the covalent bound CSP in this invention on 2,2,2-trifluoro-1-(9-anthryl)ethanol were also compared with the data that House and Duval obtained using their CSPs, respectively, and commercial products as well (Table 2). Clearly according to the separation factor, the CSP in this invention maintains a chiral separation capability similar to DaiCel's ChiralCel that is based on non-covalent bonding, even better than Daicel's covalent one, and much better than the result obtained by House or Duval. Meanwhile, the retention factor with the CSP in this invention is the lowest, which indicates the highest efficiency of chiral separation.

TABLE 2
Comparison of separation results of 2,2,2,-trifluo 1-(9-anthryl) ethanol between
the covalently bound carbamate-derivatized cellulose based CSPs in this invention and the
results obtained using the CSP of House and Duval

| | | ChiralCel | | ChiralCel | Covalent | Whelk- | CSP of |
|---|---|---|---|---|---|---|---|
| Chiral Separation | CSP of | OD of | CSP A | OD | OD | O 1 | Example 1 |
| Parameter | Example 4 | Example 5 | (House) | (House) | (House) | (House) | (Duval) |
| Separation Factor (α) | 3.65 | 3.33 | 1.57 | 3.06 | 2.32 | 1.12 | 1.70 |
| Retention Factor (k′) | 0.95 | 2.07 | 4.36 | 2.58 | — | 1.50 | — |

(Column dimension: 100 × 4.6 mm; mobile phase: hexane/isopropanol, 90/10)

### Example 8

### Column Stability Test

The HPLC column packed with the covalently bound CSPs (IV) was rinsed with 90/10 hexane/isopropanol solvents with addition of 10 vol % THF at ambient temperature. The separation performance did not show a noticeable reduction after 7300 column volumes wash, as reflected in Table 3.

TABLE 3
Comparison of separation results of some racemates
with covalently bound carbamate-derivatized cellulose
based CSPs before and after the solvent rinsing

| | Separation Factor (α) | | Retention Factor (k′) | |
|---|---|---|---|---|
| | CSP of | CSP of | CSP of | CSP of |
| | Example | Example | Example | Example |
| | 4 before | 4 after | 4 before | 4 after |
| | solvent | solvent | solvent | solvent |
| Racemate | rinsing | rinsing | rinsing | rinsing |
| 2,2,2-Trifluo 1-(9- | 3.65 | 3.34 | 0.95 | 1.00 |
| anthryl) ethanol | | | | |
| 1-Phenyl-1-propanol | 1.50 | 1.52 | 2.01 | 2.05 |
| α-Methyl-1-naphthanlene | 2.14 | 2.08 | 5.07 | 4.91 |
| methanol | | | | |
| Trans-stilbene oxide | 3.03 | 2.75 | 0.71 | 0.74 |
| Burke O₂ | 3.12 | 3.00 | 3.93 | 3.77 |
| 3,5-Dinitro-N-(1-phenyl- | 1.90 | 1.85 | 8.14 | 7.79 |
| ethyl) benzamide | | | | |
| Napropamide | 1.59 | 1.57 | 0.65 | 0.62 |

(Column dimension: 100 × 4.6 mm; mobile phase: hexane/isopropanol, 90/10)

### REFERENCES

### U.S. Patent Documents

U.S. Pat. No. 4,619,970, Oct. 28, 1986, Okamoto
U.S. Pat. No. 4,861,872, Aug. 29, 1989, Okamoto
U.S. Pat. No. 5,268,442, Dec. 7, 1993, Bradshaw
U.S. Pat. No. 5,589,061, Dec. 31, 1996, Russell
U.S. Pat. No. 5,811,532, Sep. 22, 1998, House
U.S. Pat. No. 6,013,738, Jan. 11, 2000, Daly
U.S. Pat. No. 6,342,592, Jan. 29, 2002, Duval
application Ser. No. 09/808,910 (Pub. No. 2002/0058763A1), May 16, 2002, Duval

### Other Patent Documents

Japanese Pat. No. 1992169595
European Pat. No. 0155637B, Okamoto
Japanese Pat. No. 06206893A, Okamoto
Int. Pat. Appl. No. WO96/27615A, Francotte
Int. Pat. Appl. No. WO97/04011A, Francotte
Int. Pat. Appl. No. WO95/18833A, Olveros
European Pat. No. 807, 460, 1997, Diamantoglu

### Other References

El Seoud O A, Heinze T. Adv. Polym. Sci. 2005, 186, 103-149.
Ichida A, Shibata T, Okamoto I. Chromatogr. 1987, 24, 552-554.
Okamoto Y, Kawashima M, Hataka, K. J. Am. Chem. Soc. 1984, 106, 5357-5359.
Okamoto Y, Kaida Y. J. Chromatogr. A 1994, 666, 403-419.
Okamoto Y, Kawashima M, Hatada K. J. Chromatogr. A 1986, 363, 173-186.
Okamoto Y. J. Liq. Chromatogr. 1987, 10, 1613-28.
Oliveros L, Lopez P, Minguillon C, Franco P. J. Liq. Chromatogr. 1995, 18, 1521.
Stuurman H W, Köhler J, Schomburg G. Chromatogr. 1998, 25, 265-271.
Yashima E, Fukaya H, Okamoto Y. J. Chromatogr. A 1994, 677, 11-19.
Zhang T, Francotte E. Chirality 1995, 7, 425-433.

1. A chromatographic chiral stationary phase comprising: (a) a polysaccharide; (b) an inorganic oxide carrier; (c) a covalent linkage of the structure 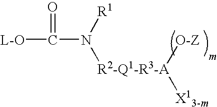
between the polysaccharide and the inorganic oxide carrier,
wherein L is polysaccharide;
Z is inorganic oxide carrier;
m=1-3;
A is Si, Ti, or Zr;
X¹ is selected from the group consisting of hydrogen, halogen, hydroxyl, alkoxy, acetoxy, siloxane, unsubstituted or substituted alkyl hydrocarbon, unsubstituted or substituted alkenyl hydrocarbon, unsubstituted or substituted aryl hydrocarbon, unsubstituted or substituted mixed alkyl-aryl hydrocarbons, and combinations thereof, wherein the substituents may be selected from the group consisting of halogen, alkoxy, epoxy, hydroxyl, aldehyde, carboxyl, acetoxy, mercapto, amino, cyano, nitro, sulfonyl, and silyl;
R¹ is selected from the group consisting of unsubstituted or substituted alkyl, unsubstituted or substituted alkenyl, unsubstituted or substituted aryl, unsubstituted or substituted mixed alkyl-aryl hydrocarbons, and combinations thereof, wherein the substituents may be selected from the group consisting of halogen, alkoxy, epoxy, aldehyde, carboxyl, acetoxy, tertiary amino, cyano, nitro, sulfonyl, and silyl;
R² and R³ are independently unsubstituted or substituted alkyl, unsubstituted or substituted alkenyl, unsubstituted or substituted aryl, unsubstituted or substituted mixed alkyl-aryl hydrocarbons, wherein the substituents may be selected from the group consisting of halogen, alkoxy, epoxy, hydroxyl, aldehyde, carboxyl, acetoxy, mercapto, amino, cyano, nitro, sulfonyl, and silyl; and 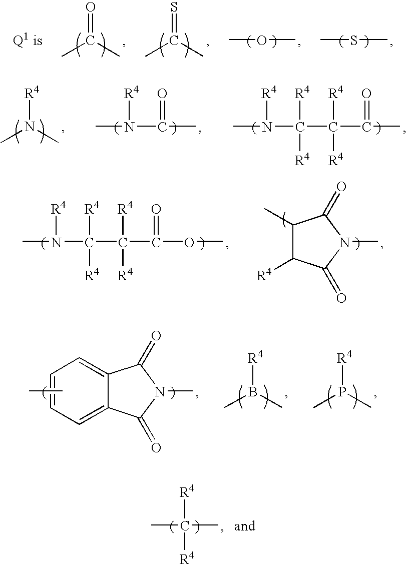
combinations thereof, wherein each occurrence of R⁴ is independently selected from hydrogen, alkyl hydrocarbon, and aryl hydrocarbon.

2. A chromatographic chiral stationary phase comprising: (a) a polysaccharide; (b) an inorganic oxide carrier; (c) a covalent linkage of the structure 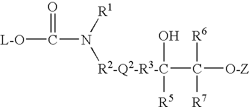
between the polysaccharide and the inorganic oxide carrier,
wherein L is polysaccharide;
Z is inorganic oxide carrier;
R¹ is selected from the group consisting of unsubstituted or substituted alkyl, unsubstituted or substituted alkenyl, unsubstituted or substituted aryl, unsubstituted or substituted mixed alkyl-aryl hydrocarbons, and combinations thereof, wherein the substituents may be selected from the group consisting of halogen, alkoxy, epoxy, aldehyde, carboxyl, acetoxy, tertiary amino, cyano, nitro, sulfonyl, and silyl;
R², R³, R⁵, R⁶ and R⁷ are independently unsubstituted or substituted alkyl, unsubstituted or substituted alkenyl, unsubstituted or substituted aryl, unsubstituted or substituted mixed alkyl-aryl hydrocarbons, wherein the substituents may be selected from the group consisting of halogen, alkoxy, epoxy, hydroxyl, aldehyde, carboxyl, acetoxy, mercapto, amino, cyano, nitro, sulfonyl, and silyl; and
Q² is 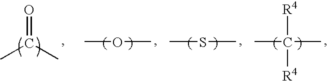
and combinations thereof, wherein each occurrence of R⁴ is independently selected from hydrogen, alkyl hydrocarbon, and aryl hydrocarbon.

3. A chromatographic chiral stationary phase comprising: (a) a polysaccharide; (b) an inorganic oxide carrier; (c) a covalent linkage of the structure 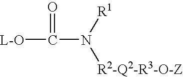
between the polysaccharide and the inorganic oxide carrier,
wherein L is polysaccharide;
Z is inorganic oxide carrier;
R¹ is selected from the group consisting of unsubstituted or substituted alkyl, unsubstituted or substituted alkenyl, unsubstituted or substituted aryl, unsubstituted or substituted mixed alkyl-aryl hydrocarbons, and combinations thereof, wherein the substituents may be selected from the group consisting of halogen, alkoxy, epoxy, aldehyde, carboxyl, acetoxy, tertiary amino, cyano, nitro, sulfonyl, and silyl;
R² and R³ are independently unsubstituted or substituted alkyl, unsubstituted or substituted alkenyl, unsubstituted or substituted aryl, unsubstituted or substituted mixed alkyl-aryl hydrocarbons, wherein the substituents may be selected from the group consisting of halogen, alkoxy, epoxy, hydroxyl, aldehyde, carboxyl, acetoxy, mercapto, amino, cyano, nitro, sulfonyl, and silyl; and
Q² is 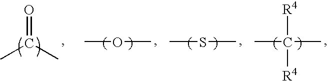
and combinations thereof, wherein each occurrence of R⁴ is independently selected from hydrogen, alkyl hydrocarbon, and aryl hydrocarbon.

4. The chiral stationary phase in any of claim 1, claim 2, and claim 3, wherein the polysaccharide is selected from the group consisting of cellulose, amylose, amylopectin, dextran, inulin, levan, chitin, pullulan, agarose, starch, and combinations thereof.

5. The chiral stationary phase of claim 4, wherein the polysaccharide is cellulose or amylose.

6. The chiral stationary phase in any of claim 1, claim 2, and claim 3, wherein the inorganic oxide carrier is selected from the group consisting of aluminum oxide, titanium oxide, magnesium oxide, zirconium oxide, zirconium silicate, zinc oxide, chromium oxide, silica, silicate, glass spheres, boron oxide, iron oxide, and combinations thereof.

7. The chiral stationary phase of claim 6, wherein the inorganic oxide carrier is silica, zirconium oxide, or aluminum oxide.

8. The chiral stationary phase of claim 7, wherein the inorganic oxide carrier is silica.

9. The chiral stationary phase in any of claim 1, claim 2, and claim 3, wherein the inorganic oxide carrier has a particle size of between 0.05 and 500 micron.

10. The chiral stationary phase in any of claim 1, claim 2, and claim 3, wherein the inorganic oxide carrier has a surface area greater than 20 m²/g.

11. The chiral stationary phase in any of claim 1, claim 2, and claim 3, wherein the inorganic oxide carrier is porous.

12. The chiral stationary phase of claim 11, wherein the inorganic oxide carrier has a pore size of between 20 and 4000 angstrom.

13. A method for preparing a chromatographic chiral stationary phase, which comprises the steps of:
a) derivatizing polysaccharides by reacting regular polysaccharides with isocyanate compounds of formula R¹—NCO to produce carbamate-derivatized polysaccharides, wherein R¹ is selected from the group consisting of unsubstituted or substituted alkyl, unsubstituted or substituted alkenyl, unsubstituted or substituted aryl, unsubstituted or substituted mixed alkyl-aryl hydrocarbons, and combinations thereof, wherein the substituents may be selected from the group consisting of halogen, alkoxy, epoxy, aldehyde, carboxyl, acetoxy, tertiary amino, cyano, nitro, sulfonyl, and silyl;
b) deprotonating the said carbamate-derivatized polysaccharides with a base;
c) grafting alkenyl groups onto the said deprotonated carbamate-derivatized polysaccharides by reacting with an unsaturated compound selected from alkenyl compounds of formula X²-J-CH═CH—R⁸ and alkynyl compounds of formula X²-J-C≡C—R⁸ wherein X² is a leaving group independently selected from the group consisting of Cl, Br, I, TsO—, MsO—, and TfO—; J is alkyl, aryl, or mixed alkyl-aryl hydrocarbons; R⁸ is independently hydrogen, alkyl, aryl, or mixed alkyl-aryl hydrocarbons;
d) grafting hydroxyl-reactive groups onto the said alkenyl functionalized carbamate-derivatized polysaccharides by reacting with a silane compound of formula HSiX³ₙX⁴₃₋ₙ via hydrosilation, wherein X³ is alkoxy, halide, acetoxy, tertiary amino, enoxy, or oxime; X⁴ is selected from the group consisting of hydrogen, hydroxyl, alkyl hydrocarbon, alkenyl hydrocarbon, aryl hydrocarbon, mixed alkyl-aryl hydrocarbons, and combinations thereof, n=1-3; and
e) coating and condensating the said hydroxyl-reactive carbamate-derivatized polysaccharides onto an inorganic oxide carrier.

14. A method for preparing a chromatographic chiral stationary phase, which comprises the steps of:
a) derivatizing polysaccharides by reacting regular polysaccharides with isocyanate compounds of formula R¹—NCO to produce carbamate-derivatized polysaccharides, wherein R¹ is selected from the group consisting of unsubstituted or substituted alkyl, unsubstituted or substituted alkenyl, unsubstituted or substituted aryl, unsubstituted or substituted mixed alkyl-aryl hydrocarbons, and combinations thereof, wherein the substituents may be selected from the group consisting of halogen, alkoxy, epoxy, aldehyde, carboxyl, acetoxy, tertiary amino, cyano, nitro, sulfonyl, and silyl;
b) deprotonating the said carbamate-derivatized polysaccharides with a base;
c) grafting hydroxyl-reactive groups onto the said deprotonated carbamate-derivatized polysaccharides by reacting with a compound of formula X²-T-AX³ₙX⁴₃₋ₙ, wherein X² is a leaving group selected from the group consisting of Cl, Br, I, TsO—, MsO—, and TfO—; T is alkyl, alkenyl, aryl, or mixed alkyl-aryl hydrocarbons; A is Si, Ti, or Zr; X³ is alkoxy, halide, acetoxy, tertiary amino, enoxy, or oxime; X⁴ is selected from the group consisting of hydrogen, hydroxyl, alkyl hydrocarbon, alkenyl hydrocarbon, aryl hydrocarbon, mixed alkyl-aryl hydrocarbons, and combinations thereof, n=1-3; and
d) coating and condensating the hydroxyl-reactive carbamate-derivatized polysaccharides onto an inorganic oxide carrier.

15. A method for preparing a chromatographic chiral stationary phase, which comprises the steps of:
a) derivatizing polysaccharides by reacting regular polysaccharides with an isocyanate compound of formula R¹—NCO to produce carbamate-derivatized polysaccharides, wherein R¹ is selected from the group consisting of unsubstituted or substituted alkyl, unsubstituted or substituted alkenyl, unsubstituted or substituted aryl, unsubstituted or substituted mixed alkyl-aryl hydrocarbons, and combinations thereof, wherein the substituents may be selected from the group consisting of halogen, alkoxy, epoxy, aldehyde, carboxyl, acetoxy, tertiary amino, cyano, nitro, sulfonyl, and silyl;
b) deprotonating the said carbamate-derivatized polysaccharides with a base;
c) grafting epoxy functional groups onto the said deprotonated carbamate-derivatized polysaccharides by reacting with a compound of formula X²-T-X⁵, wherein X² is a leaving group selected from the group consisting of Cl, Br, I, TsO—, MsO—, and TfO—; T is alkyl, alkenyl, aryl, or mixed alkyl-aryl hydrocarbons; X⁵ is a glycidyl, aliphatic, or cycloaliphatic epoxy group; and
d) coating and grafting upon heating the said epoxy functionalized carbamate-derivatized polysaccharides onto an inorganic oxide carrier.

16. A method for preparing a chromatographic chiral stationary phase, which comprises the steps of:
a) derivatizing polysaccharides by reacting regular polysaccharides with an isocyanate compound of formula R¹—NCO to produce carbamate-derivatized polysaccharides, wherein R¹ is selected from the group consisting of unsubstituted or substituted alkyl, unsubstituted or substituted alkenyl, unsubstituted or substituted aryl, unsubstituted or substituted mixed alkyl-aryl hydrocarbons, and combinations thereof, wherein the substituents may be selected from the group consisting of halogen, alkoxy, epoxy, aldehyde, carboxyl, acetoxy, tertiary amino, cyano, nitro, sulfonyl, and silyl;
b) deprotonating the said carbamate-derivatized polysaccharides with a base;
c) grafting functional groups onto the said deprotonated carbamate-derivatized polysaccharides by reacting with a compound of formula X²-T-X⁶, wherein X² is a leaving group selected from the group consisting of Cl, Br, I, TsO—, MsO—, and TfO—; T is alkyl, alkenyl, aryl, or mixed alkyl-aryl hydrocarbons; X⁶ is selected from the group consisting of alkene, thiol, amine, (meth)acrylate, alkene ketone, epoxide, anhydride, carboxylic acid, and aldehyde;
d) modifying an inorganic oxide carrier with covalently bound hydroxyl groups on the surface using a surface modifying or coupling agent of formula X⁶-E-AX³ₙX⁴₃₋ₙ, wherein A is Si, Ti, or Zr; X³ is alkoxy, halide, acetoxy, tertiary amino, enoxy, or oxime; X⁴ is selected from the group consisting of hydrogen, halogen, hydroxyl, alkyl hydrocarbon, alkenyl hydrocarbon, aryl hydrocarbon, mixed alkyl-aryl hydrocarbons, and combinations thereof, n=1-3; X⁶ is selected from the group consisting of alkene, thiol, amine, (meth)acrylate, alkene ketone, epoxide, anhydride, carboxylic acid, and aldehyde; E is alkyl, alkenyl, aryl, or mixed alkyl-aryl hydrocarbons; and
e) coating and grafting the functionalized carbamate-derivatized polysaccharides onto the said surface modified inorganic oxide carrier.

17. A method for preparing a chromatographic chiral stationary phase, which comprises the steps of:
a) derivatizing polysaccharides by reacting regular polysaccharides with an isocyanate compound of formula R¹—NCO to produce carbamate-derivatized polysaccharides, wherein R¹ is selected from the group consisting of unsubstituted or substituted alkyl, unsubstituted or substituted alkenyl, unsubstituted or substituted aryl, unsubstituted or substituted mixed alkyl-aryl hydrocarbons, and combinations thereof, wherein the substituents may be selected from the group consisting of halogen, alkoxy, epoxy, aldehyde, carboxyl, acetoxy, tertiary amino, cyano, nitro, sulfonyl, and silyl;
b) deprotonating the said carbamate-derivatized polysaccharides with a base;
c) grafting functional groups onto the said deprotonated carbamate-derivatized polysaccharides by reacting with a compound of formula X²-T-X⁶, wherein X² is a leaving group selected from the group consisting of Cl, Br, I, TsO—, MsO—, and TfO—; T is alkyl, alkenyl, aryl, or mixed alkyl-aryl hydrocarbons; X⁶ is hydroxyl that is protected by a compound selected from tetrahydropyran, vinyl ether, and benzyl ether;
d) the hydroxyl protecting group was removed by a benzylsulfonic acid to produce hydroxyl functionalized carbamate-derivatized polysaccharides; and
e) coating and grafting the hydroxyl functionalized carbamate-derivatized polysaccharides onto inorganic oxide carrier upon heating.

18. The method in any of claim 13, claim 14, claim 15, claim 16, and claim 17, wherein the polysaccharides are derivatized such that the said polysaccharides become completely soluble at the end of the reaction.

19. The method in any of claim 13, claim 14, claim 15, claim 16, and claim 17, wherein the isocyanate compound is selected from aryl isocyanate, cycloalkyl isocyanate, and combinations thereof.

20. The method of claim 19, wherein the aryl isocyanate compound is phenyl isocyanate, α-methylbenzyl isocyanate, tolyl isocyanate, fluorophenyl isocyanate, chlorophenyl isocyanate, bromophenyl isocyanate, iodophenyl isocyanate, ethylphenyl isocyanate, isopropylphenyl isocyanate, tert-butylphenyl isocyanate, alkoxyphenyl isocyanate, (trifluoromethyl)phenyl isocyanate, nitrophenyl isocyanate, fluoromethylphenyl isocyanate, chloromethylphenyl isocyanate, bromomethylphenyl isocyanate, di(trifluoromethyl)phenyl isocyanate, dimethylphenyl isocyanate, difluorophenyl isocyanate, or dichlorophenyl isocyanate.

21. The method of claim 20, wherein the aryl isocyanate compound is 3,5-dimethylphenyl isocyanate, 3,5-dichlorophenyl isocyanate, 3-fluoro-5-methylphenyl isocyanate, 2-methyl-5-fluorophenyl isocyanate, 4-methylphenyl isocyanate, 4-chlorophenyl isocyanate, α-methylbenzyl isocyanate, or phenyl isocyanate.

22. The method of claim 19, wherein the cycloalkyl isocyanate compound is cyclopentyl isocyanate, cyclohexyl isocyanate, cycloheptyl isocyanate, cyclooctyl isocyanate, cyclododecyl isocyanate, cyclohexanemethyl isocyanate, norbonyl isocyanate, or adamantyl isocyanate.

23. The method of claim 22, wherein the cycloalkyl isocyanate compound is cyclopentyl isocyanate, cyclohexyl isocyanate, norbonyl isocyanate, or adamantyl isocyanate.

24. The method in any of claim 13, claim 14, claim 15, claim 16, and claim 17, wherein the base is selected from the group consisting of metal hydride, metal alkoxide, alkali metal amide, alkali metal alkylate, alkali metal carbonate or alkaline earth metal carbonate combined with copper (I) halide, and combinations thereof.

25. The method of claim 24, wherein the base is sodium hydride.

26. The method in any of claim 13, claim 14, claim 15, claim 16, and claim 17, wherein the carbamate-derivatized polysaccharides are functionalized under homogeneous reaction conditions.

27. The method in any of claim 13, claim 14, claim 15, claim 16, and claim 17, wherein the polysaccharides are functionalized such that there is between 1 and 50 functional groups on each of the carbamate-derivatized polysaccharide molecules.

28. The method of claim 27, wherein the polysaccharides are functionalized such that there is between 1 and 20 functional groups on each of the carbamate-derivatized polysaccharide molecules.

29. The method of claim 28, wherein the polysaccharides are functionalized such that there is between 1 and 10 functional groups on each of the carbamate-derivatized polysaccharide molecules.

30. The method in any of claim 13, claim 14, claim 15, and claim 17, wherein the inorganic oxide carrier has covalently bound hydroxyl groups on the surface.

31. The method of claim 16, wherein the grafting is a coupling reaction selected from the group consisting of thiol/ene addition, Michael addition, epoxy/amine ring-opening addition, acid/amine condensation, anhydride/amine condensation, aldehyde/amine condensation, and ene/ene metathesis.

32. The method of claim 31, wherein the grafting is obtained using a catalyst.

33. The method of claim 17, wherein the grafting by coupling reaction is obtained upon heating at a temperature preferably greater than 60° C., more preferably greater than 80° C., and most preferably greater than 100° C.

34. The method of claim 17, wherein the grafting by coupling reaction is obtained under vacuum.
